(19) United States
(12) Patent Application Publication
(10) Pub. No.: US 2019/0268814 A1
(43) Pub. Date: Aug. 29, 2019

(54) Network Node and Methods Therein for User Plane Switching

(71) Applicant: Telefonaktiebolaget LM Ericsson (publ), Stockholm (SE)

(72) Inventors: Hans HANNU, LULEÅ (SE); Jan CHRISTOFFERSSON, LULEÅ (SE); Mårten ERICSON, LULEÅ (SE); Min WANG, LULEÅ (SE)

(21) Appl. No.: 16/348,396

(22) PCT Filed: Nov. 9, 2016
(86) PCT No.: PCT/SE2016/051101

§ 371 Date: May 8, 2019

(51) Int. Cl. H04W 36/00

(52) U.S. Cl. CPC H04W 36/00837; H04W 36/0072; H04W 36/0069

(57) ABSTRACT

A method for operating a network node. The network node provides (503) an indication of a time for switching a radio link for a user plane associated with a wireless communication device. The radio link is switched from a first radio link, associated with a first network node, to a second radio link, associated with a second network node. The time for switching the radio link is based on an obtained indication of a transmission opportunity of a user plane data at the second network node.

### TECHNICAL FIELD

Embodiments herein relate to a network node and methods therein. In particular they relate to user plane switching in a wireless communications network.

### BACKGROUND

Wireless communication devices such as terminals are also known as e.g. User Equipments (UE), mobile terminals, wireless terminals andor mobile stations. These terms will be used interchangeably hereafter.

Wireless communication devices are enabled to communicate wirelessly in a wireless or cellular communications network or a wireless communication system, sometimes also referred to as a cellular radio system or a cellular network. The communication may be performed e.g. between two wireless communications devices, between a wireless communications device and a regular telephone andor between a wireless communications device and a server via a Radio Access Network (RAN) and possibly one or more core networks, comprised within the wireless communications network.

Access network nodes, also referred to as access nodes, such as base stations, communicate over the air interface operating on radio frequencies with the wireless communication devices within range of the access network nodes. In the context of this disclosure, the expression Downlink (DL) is used for the transmission path from the access network node to the wireless communication devices. The expression Uplink (UL) is used for the transmission path in the opposite direction i.e. from the wireless communication devices to the access network node.

Further, each access network node may support one or several communications technologies or radio interfaces also referred to as Radio Access Technologies (RAT). Examples of wireless communication technologies are New Radio (NR), Long Term Evolution (LTE), Universal Mobile Telecommunications System (UMTS) and Global System for Mobile communications (GSM).

In a forum known as the Third Generation Partnership Project (3GPP), telecommunications suppliers propose and agree upon standards for networks and investigate enhanced data rate and radio capacity.

### Mobility

Mobility is a requirement in many wireless communications networks. The wireless communications network supports mobility of the wireless communication device, e.g. service continuity of the wireless communications device, e.g. by transferring a connection between the wireless communications network and the wireless communications device from one cell to another cell or from one access network node to another access network node, commonly referred to as handover.

The handover should happen without any loss of data and with as small interrupt as possible.

In LTE, handover controlled by the wireless communications network and assisted by the wireless communications device is utilized, for example as described by 3GPP TS 36.300 version 14.0.0. The wireless communications device is moved, if required and if possible, to the most appropriate cell that assures service continuity and quality.

The telecommunication industry is currently developing a fifth generation mobile telecommunication system, 5G. The NR of 5G may operate on higher frequencies than current LTE which is a fourth generation RAT. Hence, it is likely that an NR base station, e.g. a base station operating according to an NR standard, may cover only a part of the area of what an LTE base station does.

FIG. 1 illustrates three typical coverage scenarios for co-existing LTE and NR RANs. The NR RANs are marked with a dashed or filled coverage area. The coverage scenario to the left side is an initial coverage scenario, while long term scenarios are illustrated to the right. The upper right scenario corresponds to co-located coverage areas, while the lower right corresponds to non co-located coverage areas.

In addition to a higher pathloss for the NR frequency bands, the higher frequencies also imply a more challenging propagation condition of radio signals in terms of lower diffraction and higher outdoor andor indoor penetration losses. Together with the use of beamforming in NR, this means that an NR radio link is expected to vary faster than a corresponding radio link for LTE. That is, wireless communication devices that are using NR may experience sudden drops of the signal strength at high frequencies. To overcome this, there are discussions in 3GPP to enable a “tight integration” between LTE and NR, which may mean a solution similar to Dual Connectivity (DC) in LTE. Such a solution is described in document 3GPP R2-165330, Dual Connectivity based link switch between LTE and NR. This enables a more reliable connection, since network nodes operating according to LTE, e.g. operating at lower frequencies, may ensure coverage for wireless communication devices when network nodes operating according to NR has a coverage hole.

In DC a wireless communications device, such as UE, may be served by two network nodes called master eNB (MeNB) and secondary eNB (SeNB). The wireless communication device in DC typically has separate transmitter and receiver (TxRx) for each of the connections with the MeNB and the SeNB. This allows the MeNB and SeNB to independently configure the wireless communication device with one or more procedures, e.g. radio link monitoring (RLM), Discountinous Reception (DRX) cycle etc., on their respective cells.

More specifically, a RAN of LTE, e.g. an Evolved UMTS Terrestrial RAN (E-UTRAN) supports DC operation whereby a UE with multiple Rx/Tx capabilities is configured to utilise radio resources provided by two distinct schedulers, located in two eNBs connected via a non-ideal backhaul over an X2 interface between the eNBs. Each scheduler distributes resources among wireless communication devices that have data to transmit over the radio link(s) that the scheduler handles per transmission opportunity.

The eNBs involved in DC for a certain UE may assume two different roles: an eNB may either act as the MeNB or as the SeNB. In current DC in LTE the UE is connected to one MeNB and one SeNB. DC for LTE is standardised in 3GPP TS 36.300 v.14.0.0.

A Master Cell Group (MCG) is a group of serving cells associated with the MeNB, comprising of the Primary Cell (PCell) and optionally one or more Secondary Cells (SCells). A Secondary Cell Group (SCG) is a group of serving cells associated with the SeNB, comprising of a Primary SCell (PSCell) and optionally one or more SCells.

In DC, the radio protocol architecture that a particular bearer uses depends on how the bearer is setup. Three bearer types exist: MCG bearer, SCG bearer and split bearer. The MCG bearer is a bearer whose radio protocols are only located in the MeNB to use MeNB resources only. The SCG bearer is a bearer whose radio protocols are only located in the SeNB to use SeNB resources. The split bearer is a bearer a bearer whose radio protocols are located in both the MeNB and the SeNB to use both MeNB and SeNB resources.

In DC, a wireless communication device may report measurement results in accordance with a measurement event triggering. Accordingly, depending on a content of a measurement report, a network node, such as an access network node, will take a different action upon the reception of the measurement report.

FIG. 2 illustrates an example of DC measurement events for an SeNB management and a link switch, e.g. a switch between two radio links associated with an MeNB and an SeNB.

In FIG. 2 an MeNB 201 operates according to LTE and provides radio coverage in a first area 211. Following the illustrated path of a wireless communication device 220 in FIG. 2, different events occur at different time instants. A NR eNB 202 is added as an SeNB when a mobility event is triggered, for example A4 andor B1 events in LTE. A4, as defined in LTE in 3GPP TS 36.300 v14.000, means for example that neighbour (cell) becomes better than threshold and B1 means that an inter RAT neighbour (cell) becomes better than a threshold. This may e.g. happen when the wireless communication device starts to move into an NR hot spot illustrated with a smaller dashed second area 212 in FIG. 2. From now on, the wireless communication device 220 is prepared for the data transmission from the SeNB.

The wireless communications network may choose to use so called user plane (UP) switching, using only one link of LTE or NR, or use both links simultaneously, so called UP aggregation based on the wireless communication device measurement events.

For DC two different user plane architectures are allowed: one in which an S1-U interface only terminates in the MeNB and the user plane data is transferred from MeNB to SeNB using an X2-U interface, and a second architecture where the S1-U interface may terminate in the SeNB.

Different bearer options may be configured with different user plane architectures. U-plane connectivity depends on the bearer option configured:

For MCG bearers, the S1-U connection for the corresponding bearer(s) to a Serving GateWay (S-GW) is terminated in the MeNB. The SeNB is not involved in the transport of user plane data for this type of bearer(s) over a Uu interface, i.e. between the eNB and the UE.

For split bearers, the S1-U connection to the S-GW is terminated in the MeNB. Packet Data Control Protocol (PDCP) data is transferred between the MeNB and the SeNB via the X2-U interface. The SeNB and MeNB are involved in transmitting data of this bearer type over the Uu.

For SCG bearers, the SeNB is directly connected with the S-GW via S1-U. The MeNB is not involved in the transport of user plane data for this type of bearer(s) over the Uu.

User plane data is for example data packets created by applications processed by protocols such as TCP, UDP and IP. Compared to control plane data where for example the radio resource control protocol (RRC) writes signaling messages that are exchanged between eNB and UE.

Note that there is no UP interruption foreseen during a UP switch, e.g. a link switch, since the wireless communication device may keep both links active with the LTE based DC feature.

However, it is not optimal to always utilize dual connectivity. There is always a cost to use both links to both RATs simultaneously since more network resources are used. The wireless communication devices supporting user plane aggregation may also be costlier since they require two transmitters and two receivers. There is also a cost in terms of capacity to use both links, since it is more efficient to use the best link in terms of network system capacity, also referred to as system capacity.

Therefore, the UP switch may be a better option in many cases. Note that the UP switch option may still leverage on the better LTE coverage in the same manner as the UP aggregation, since the switch is faster than a hard handover and does not imply a transmission interruption. Therefore the UP switch is sometimes referred to as Fast switch. One disadvantage with the UP switch is that the maximum potential user throughput is decreased compared to the UP aggregation.

Similar to the way handover between cells in LTE is done, switch criteria may be based on the signal strength of the channel used in the respective access technology, e.g. Reference Signal Received Power (RSRP) or some sort of quality measurement such as Signal-to-Interference-plus-Noise-Ratio (SINR) or Reference Signal Received Quality (RSRQ).

An existing Inter RAT handover to or from LTE, e.g. LTE IRAT, is one alternative for the link switch between LTE and NR. However, the IRAT handover may result in an inevitable UP interruption during which no user plane data is transmitted on the LTE link nor on the NR link.

As propagation conditions at higher frequencies are much more challenging it is likely that a radio quality of the NR link experiences a sharp degradation when the wireless communication device 220 moves away from the hot spot area 212. Thus there is a risk for handover failure when this happens, since the handover may not finish before the wireless communication device 220 has left the coverage of the SeNB 202 operating according to NR.

Prior art doc US20150371690 A1 “Selecting a Radio Access Technology Mode Based on Current Conditions” describes how to move wireless communication devices in idle mode between different RATs based on signal strength.

### SUMMARY

Even though the user plane switch from one RAT to another may be almost instant, e.g. when based on the X2 interface, it may still take some time before the wireless communication device can access the resources of the new RAT. This delay may cause a drop in throughput of the wireless communication device and may thus cause reduced Quality of Experience, e.g. for interactive services. This may e.g. happen both when all resources of the new RAT are used by already scheduled users in the new RAT or also for the case if the two RATs have different time structures, such as different Transmission Time Intervals (TTIs). FIG. 3 illustrates a prior art user plane switching along a timeline. FIG. 3 further illustrates an example of schematic time structures of NR and LTE. The time structures are exemplified with TTIs. A wireless device referred to as A misses three transmission opportunities, such as scheduling opportunities, e.g. three TTIs, on an NR link as a switch to an LTE link happens un-synchronized from a potential next LTE transmission opportunity.

It is an object of embodiments herein to solve or reduce at least some of the problems mentioned above.

A further object of embodiments herein is to improve the performance of one or more wireless communications networks by obviating at least some of the above mentioned problems.

For example, it may be an object of embodiments herein to reduce latency in the wireless communications network and to improve user data throughput.

According to a first aspect of embodiments herein it is provided a method for operating a network node.

The network node provides an indication of a time for switching a radio link for a user plane associated with a wireless communication device. The radio link is switched from a first radio link, associated with a first network node, to a second radio link associated with a second network node. The time for switching the radio link is based on an obtained indication of a transmission opportunity of a user plane data at the second network node.

According to a second aspect of embodiments herein it is provided a network node. The network node is configured to provide an indication of a time for switching a radio link for a user plane associated with a wireless communication device. The radio link is switched from a first radio link, associated with a first network node, to a second radio link associated with a second network node. The time for switching the radio link is based on an obtained indication of a transmission opportunity of a user plane data at the second network node.

The indication of the time for switching may be provided to the first network node, the second network node and the wireless communication device.

The network node provides the indication of the time for switching the radio link based on the obtained indication of the transmission opportunity at the second network node. Thereby throughput of data transmissions to and from the wireless communication device is improved in the wireless communications network since the wireless communication device is able to use transmission opportunities on the first radio link until the time for switching the user plane to the second radio link.

Further, since fewer data packets needs to be forwarded from the first network node to the second network node when the wireless communication device is able to use transmission opportunities on the first radio link until the time for switching the user plane to the second radio link, latency of the user plane is reduced since data packet forwarding of user plane data, which introduces user plane latency, is reduced.

An interactive service where latency is important will therefore gain from embodiments herein.

### BRIEF DESCRIPTION OF THE DRAWINGS

Examples of embodiments herein are described in more detail with reference to attached drawings in which:

FIG. 1 is a schematic block diagram illustrating prior art wireless communications networks.

FIG. 2 is a schematic block diagram illustrating a prior art wireless communications networks.

FIG. 3 is a schematic block diagram illustrating prior art user plane switching.

FIG. 4 is a schematic block diagram illustrating a wireless communications network.

FIG. 5 is a flowchart illustrating a method according to embodiments herein.

FIG. 6 is a schematic diagram illustrating embodiments herein.

FIG. 7a is a schematic diagram illustrating further embodiments herein.

FIG. 7b is a schematic diagram illustrating further embodiments herein.

FIG. 7c is a schematic diagram illustrating further embodiments herein.

FIG. 8a is a signalling diagram illustrating further embodiments herein.

FIG. 8b is a combined signalling diagram and flow chart illustrating further embodiments herein.

FIG. 9 is a schematic block diagram illustrating a network node according to embodiments herein.

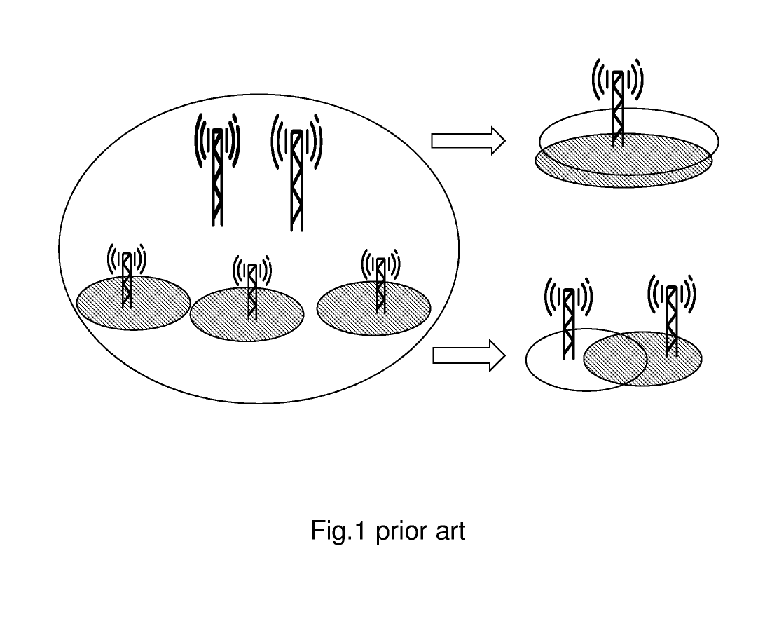

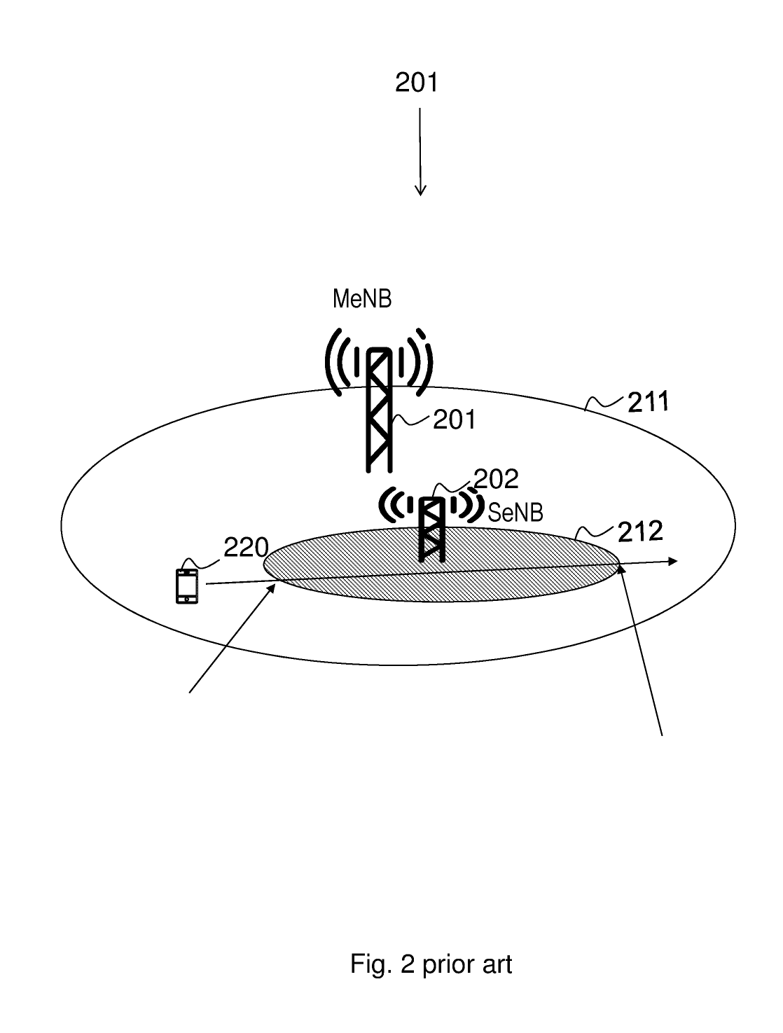

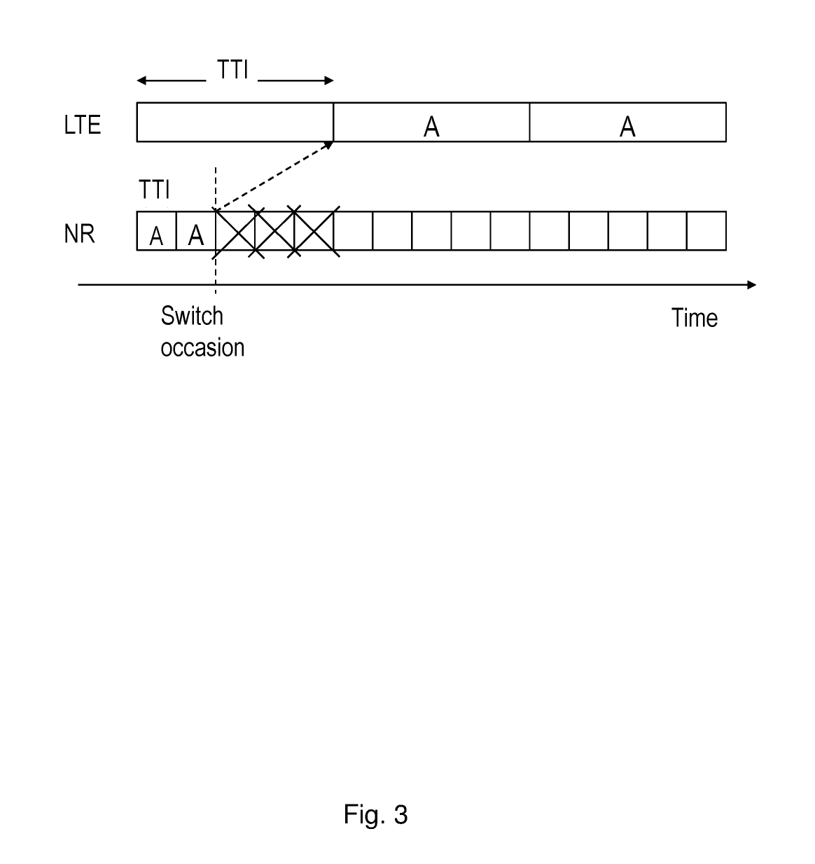

### DETAILED DESCRIPTION

Embodiments herein describe a method and apparatus for adapting a time of switching a radio link for a user plane associated with a wireless communication device. The switching is performed between two radio links. The adaptation is performed with respect to upcoming transmission opportunities of at least one of the two radio links. The radio links may belong to two different RATs.

For example, in embodiments herein a network node may align the time of switching the radio link with the upcoming transmission opportunities of the two radio links.

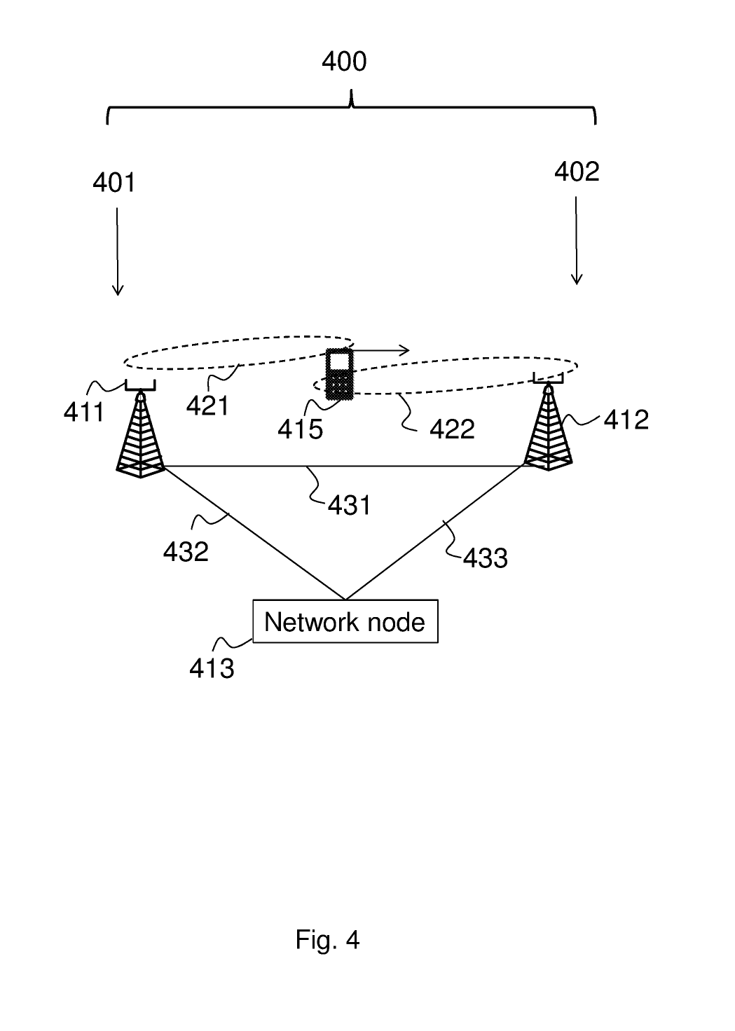

Embodiments herein may be implemented in one or more wireless communications networks. FIG. 4 depicts parts of such a wireless communications network 400. The wireless communications network 400 may comprise one or more RANs, such as a first RAN 401 and a second RAN 402. In some embodiments herein the first RAN 401 and the second RAN 402 is the same RAN. In some embodiments herein the first RAN 401 and the second RAN 402 are comprised in two different wireless communications networks, e.g. operated by two different operators.

Further, the first RAN 401 may for example operate according to a first RAT, such as NR. The second RAN 402 may operate according to a second RAT, such as LTE. NR and LTE will hereafter be used to exemplify the embodiments although the embodiments are thus not limited thereto.

The first RAN 401 and the second RAN 402 comprises a plurality of access network nodes andor other network nodes. More specifically, embodiments herein may be implemented in a network node 411, 412, 413 comprised in the wireless communications network 400. The network node 411, 412, 413 may e.g. be a first network node 411, such as a first access network node. The first network node 411 may be comprised in the first RAN 401, or in other words may operate according to the first RAT.

The wireless communications network 400 further comprises a second network node 412, such as a second access network node. The second network node 412 may be comprised in the second RAN 402, or in other words may operate according to the second RAT. In some embodiments the network node 411, 412, 413 is the second network node 412.

In particular, the time structures for transmissions of the first network node 411 and the time structures for transmissions of the second network node 412 may be different. For example, the TTIs may be different. The TTI is a parameter related to encapsulation of data from higher layers into frames for transmission on the radio link layer. TTI refers to the duration of a transmission on the radio link. The TTI is related to the size of the data blocks passed from the higher network layers to the radio link layer.

Thus the first network node 411 may operate according to a first time structure, e.g. according to a time structure associated with NR. For example, in the time domain, NR transmissions may be organized into TTIs, subframes, e.g. of a length of 0.2 ms.

The second network node 412 may operate according to a second time structure, e.g. according to a time structure associated with LTE. For example, in the time domain, LTE downlink transmissions may be organized into radio frames of 10 ms, each radio frame having ten equally-sized subframes, e.g. TTIs, of length Tsubframe=1 ms.

The terms “access network node” andor “access node” may correspond to any type of radio network node or any network node which communicates with at least a radio network node. For example, the first network node 411 and the second network node 412 may each be a base station, such as an eNB. The base station may also be referred to as a NodeB, an evolved Node B (eNB, eNode B), a base transceiver station (BTS), Access Point (AP) Base Station, Wi-Fi AP, base station router, or any other network unit capable of communicating with a wireless communications device within a coverage area served by the base station depending e.g. on the radio access technology and terminology used. The term “access network node” andor “access node” may also denote a network node or unit capable of controlling one or more other network units which are capable of communicating with a wireless communication device. Such a network node may e.g. be a Radio Network Controller (RNC), a Master eNB, a centralized baseband unit, a Centralized RAN (C-RAN) or a cluster head. Such a network node or unit may also be capable of communicating with a wireless device via one or more network units which are capable of communicating with a wireless device via a radio interface.

In some embodiments the network node 411, 412, 413 is a third network node 413 comprised in the wireless communications network 400. The third network node 413 may be a network node that holds a PDCP layer implementation, sometimes referred to as a packet processing unit as part of a virtualized RAN. The third network node 413 may also be an RNC.

In embodiments herein the first network node 411 serves wireless communications devices, such as a wireless communications device 415.

The wireless communications device 415 may further be e.g. a mobile terminal or a wireless terminal, a mobile phone, a computer such as e.g. a laptop, a Personal Digital Assistants (PDAs) or a tablet computer, sometimes referred to as a surf plate, with wireless capability, target device, device to device UE, Machine Type Communication UE or UE capable of machine to machine communication, iPad, mobile terminals, smart phone, Laptop Embedded Equipment (LEE), Laptop Mounted Equipment (LME), USB dongles etc. or any other radio network units capable to communicate over a radio link in a wireless communications network.

Please note the term User Equipment used in this disclosure also covers other wireless devices such as Machine to machine (M2M) devices, even though they are not operated by any user.

The first network node 411 may communicate with the wireless communications device 415 over a radio link, such as a first radio link 421, associated with the first network node 411. The second network node 412 may communicate with the wireless communications device 415 over a second radio link 422, associated with the second network node 412.

The first radio link 421 and the second radio link 422 may be used for a user plane associated with the wireless communication device 415. More specifically, the first radio link 421 and the second radio link 422 may be used for transmitting user plane data associated with the wireless communication device 415 over the air interface between the wireless communication device 415 and the first network node 411 and the second network node 412 respectively.

In embodiments herein user plane data may refer to user plane packets andor user plane data packets andor user plane data units.

When the first network node 411 transmits the user plane data over the first radio link 421 it organizes and transmits the user plane data according to the time structure of the first RAT. Similarly, when the second network node 412 transmits the user plane data over the second radio link 422 it organizes and transmits the user plane data according to the time structure of the second RAT.

The wireless communications network 400 may further comprise cells. For example, if the second RAN 402 operates according to LTE then the second RAN 402 may comprise cells. A cell is a geographical area where radio coverage is provided by network node equipment such as Wi-Fi AP equipment, base station equipment at a base station site or at remote locations in Remote Radio Units (RRU). The first network node 411 and the second network node 412 may each be an example of such network node equipment.

If any of the RANs, such as the first RAN 401, operates according to NR, then radio beams may have a similar function as the cells described above.

The first network node 411 may communicate with the second network node 412, e.g. over a first interface 431, such as an X2-interface. Further, the first network node 411 may communicate with the third network node 413 over a second interface 432, and the second network node 412 may communicate with the third network node 413 over a third interface 433.

As mentioned above, in DC a wireless communication device, such as the wireless communications device 415, may be served by two network nodes called MeNB and SeNB. The wireless communication device in DC typically has a separate transmitterreceiver pair for each of the connections with MeNB and SeNB. This allows the MeNB and SeNB to independently configure the wireless communication device with one or more procedures e.g. RLM, DRX cycle etc. on their PCell and PSCell respectively.

In some examples below it will be assumed that the first network node 411 is an MeNB in embodiments herein, and that the second network node 412 is an SeNB. However, embodiments are not limited thereto. For example, the first network node 411 may be an SeNB and the second network node 412 may be an MeNB.

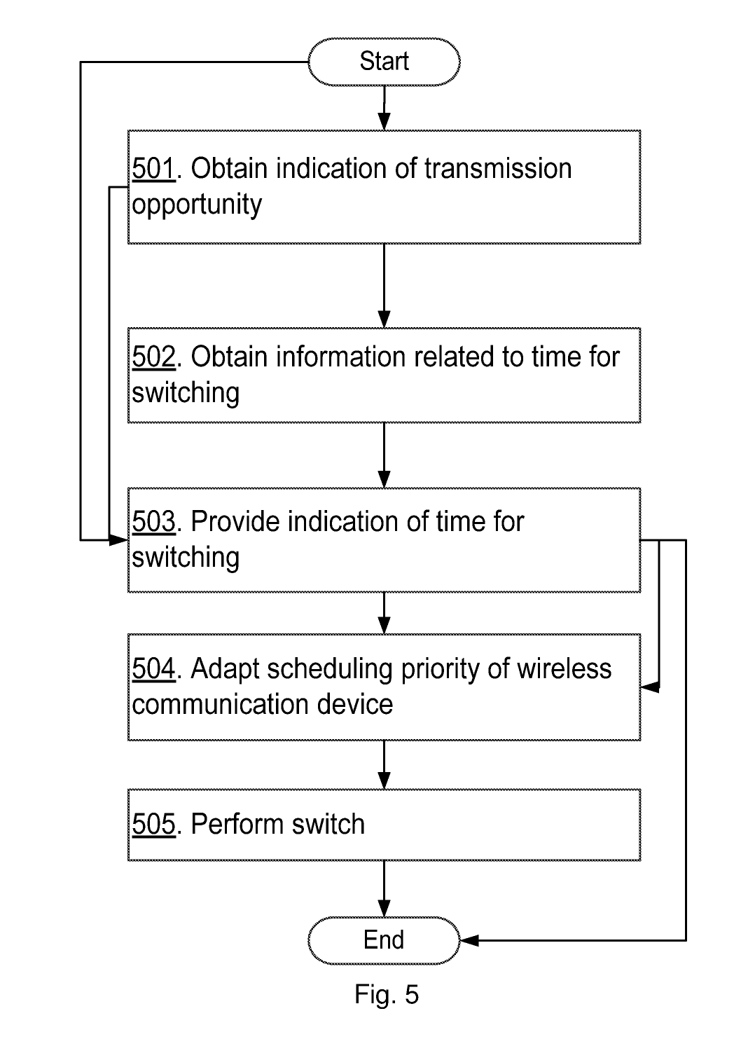

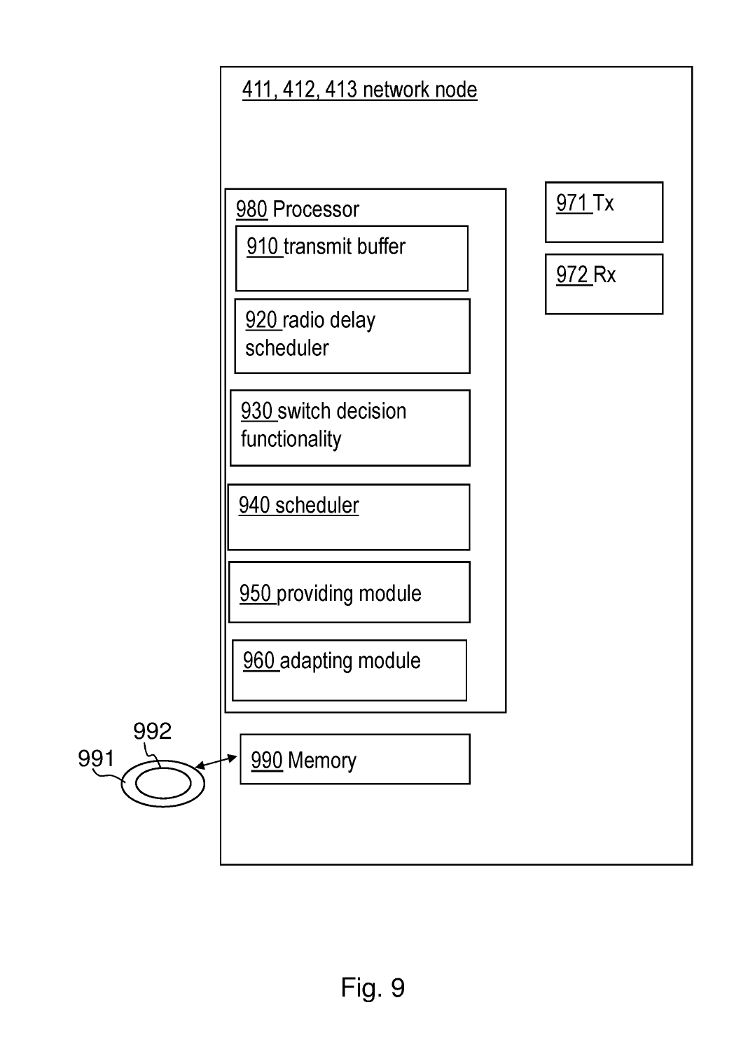

Embodiments for operating the network node 411, 412, 413, will now be described with reference to a flow chart of FIG. 5 and with continued reference to FIG. 4. Some embodiments will further be described with reference to FIG. 9, which schematically describes the network node 411, 412, 413.

In a scenario herein the wireless communication device 415 is connected to the first network node 411 through the first radio link 421. However, radio conditions are such that a switch of the user plane from the first radio link 421 to the first radio link 422 may be needed.

Embodiments herein are related to an establishment of a time for switching a radio link, or in other words a switch time or a switch occasion, e.g. when the actual switch of the first radio link 421 to the second radio link 422 happens. For the downlink, the switch time may be a point in time or a time instance, e.g. a TTI, when the wireless communication device 415 shall expect data on the second radio link 422 or on the first radio link 421. And for the uplink, the switch time may be a point in time or a time instance, e.g. a TTI, when the first network node 411 or the second network node 412 shall expect data on the respective first or second radio link 421, 422.

For a descriptive purpose it assumed that a user plane split occurs at the PDCP layer and that each RAT schedule wireless communications devices independently from each other.

It should be noted that embodiments below are not mutually exclusive. Components from one embodiment may be tacitly assumed to be present in another embodiment and it will be obvious to a person skilled in the art how those components may be used in the other exemplary embodiments.

### Action 501

In order for the network node 411, 412, 413 to determine and provide an indication of a time for switching the radio link in action 503 below, the network node 411, 412, 413 may obtain an indication of a transmission opportunity of the user plane data at the second network node 412. The transmission opportunity of the user plane data may be a transmission opportunity in downlink as well as in uplink. Thus, the user plane data may be downlink user plane data as well as uplink user plane data. As mentioned above, the user plane data is associated with the wireless communication device 415. The transmission opportunity may e.g. be one or more scheduling occasions, such as TTIs.

In some further embodiments the network node 411, 412, 413 may also obtain an indication of a transmission opportunity of the user plane data at the first network node 411.

For example, the first network node 411 may receive the indication of the transmission opportunity of the user plane data at the second network node 412 from the second network node 412, e.g. over the first interface 431.

In another example, the third network node 413 receives the indication of the transmission opportunity of the user plane data at the second network node 412 from the second network node 412, e.g. over the third interface 433.

The third network node 413 may also receive the indication of the transmission opportunity of the user plane data at the first network node 411 from the first network node 411, e.g. over the second interface 432.

In some further embodiments the first network node 411 obtains the indication of the transmission opportunity of the user plane data at the first network node 411 internally from itself.

In a similar way the second network node 412 may also obtain the above indications.

The respective indications may each be e.g. an index, a bitmap or a value of a time parameter related to the time structure of the respective RATs, such as a value of a TTI, a time frame or a subframe.

### Action 502

The network node 411, 412, 413 may obtain further information or further indications that may be used for setting the time for switching the radio link for the user plane associated with the wireless communication device 415. The further information may be obtained together with the one or more of the indications of the transmission opportunities. For example, the further information may be obtained by receiving it from the first network node 411 andor from the second network node 412, e.g. over any of the interfaces 431, 432, 433, such as the X2-interface. The further information may also be obtained by obtaining it internally e.g. over an interface from a storage medium or a memory.

The further information may be related to an amount of remaining user plane data at the first network node 411 andor a scheduling probability of the wireless communication device 415 at the first network node 411 andor the second network node 412.

The further information may be related to the way the network nodes 411, 412 grant access to the respective radio link 421, 422.

In more detail, the information for setting the time for switching may comprise an amount of data, associated with the wireless communication device 415, in a transmit buffer 910 of the first network node 411. The information may further comprise an estimate of a bit rate of the first radio link 421. The transmit buffer 910 may be part of a memory 990 in the network node 411, 412, 413.

The information may further comprise a first probability that the first network node 411 schedules the wireless communication device 415 at the transmission opportunity at the first network node 412. The information may further comprise a second probability that the second network node 412 schedules the wireless communication device 415 at the transmission opportunity at the second network node 412.

The information for setting the time for switching may e.g. be obtained from the first network node 411 andor the second network node 412.

The further information may further comprise e.g. operator policy, user plane data type such as Voice, or Web browsing. The further information or further indications may e.g. be an index, a bitmap or a value.

### Action 503

The network node 411, 412, 413 provides an indication of the time for switching the radio link for the user plane associated with the wireless communication device 415.

As mentioned above, the time for switching may be a point in time or a time instance, e.g. a TTI. The radio link is switched from the first radio link 421, associated with the first network node 411, to the second radio link 422 associated with the second network node 412. The time for switching the radio link is based on the obtained indication of the transmission opportunity of the user plane data at the second network node 412.

The indication of the time for switching may be provided to the first network node 411 andor the second network node 412 andor the wireless communication device 415. For example, if the network node 411, 412, 413 is the first network node 411 and the wireless communication device 415 is to switch to the second radio link 422, then the first network node 411 may provide the indication of the time for switching to the wireless communication device 415 and to the second network node 412.

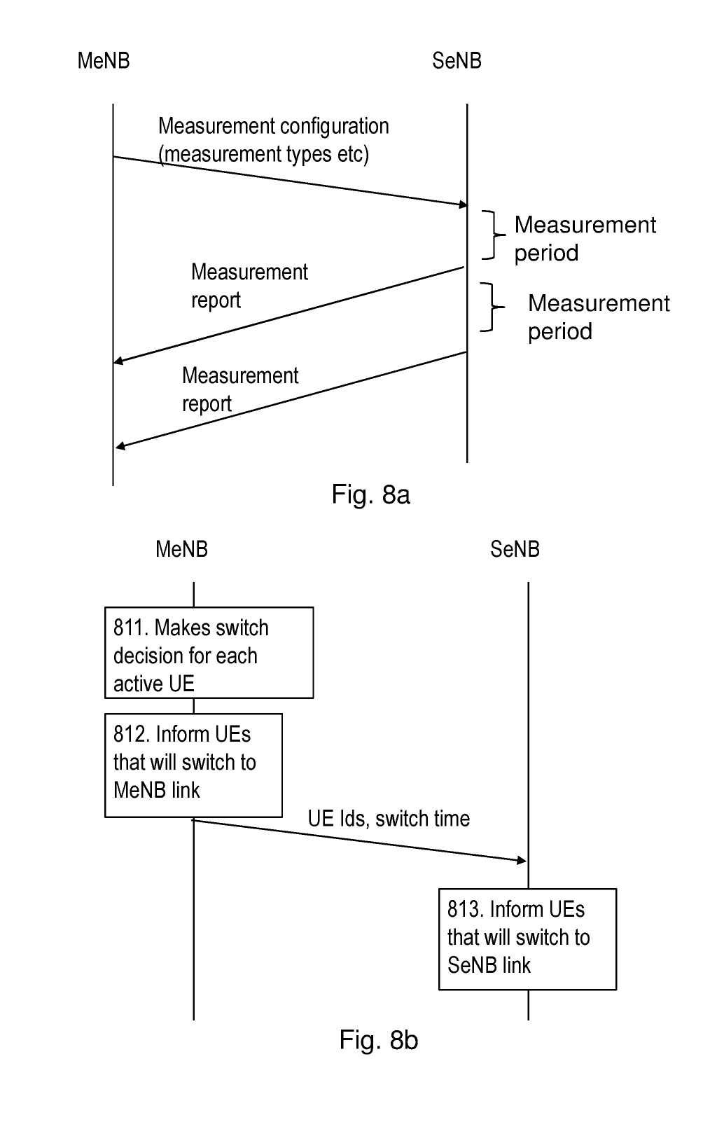

Further, providing an indication may comprise providing via an interface, such as e.g. an interface to a storage medium or a memory or an interface for transmission to another node, e.g. an eNB or another network node. This will be described further in relation to FIG. 8b below.

Since the time for switching the radio link is based on the obtained indication of the transmission opportunity at the second network node, throughput of data transmissions is improved in the wireless communications network since the wireless communication device is able to use transmission opportunities, such as transmission time intervals, on the first radio link until the time for switching the user plane to the second radio link.

Further, since fewer data packets needs to be forwarded from the first network node 411 to the second network node 412 when the wireless communication device 415 is able to use transmission opportunities on the first radio link 421 until the time for switching the user plane to the second radio link 422, latency of the user plane is reduced since data packet forwarding of the user plane data, which introduces user plane latency, is reduced.

In some embodiments the time for switching is set just prior to the next transmission opportunity, such as the next scheduling occasion of a transmitter in the second network node 412 for the user plane data at the second network node 412.

In some embodiments herein the time for switching is further based on the obtained indication of the transmission opportunity of the user plane data at the first network node 411. Having knowledge about the time structure of both the first radio link 421 and the second radio link 422 and the relation between these time structures further improves the setting and the providing of the time for switching since it is possible to align the time for switching with both time structures and thereby a throughput of user plane data may be optimized with regard to both radio links.

In some further embodiments herein the time for switching is further based on any one or more of:

an amount of data, such as DL user plane data andor an UL user plane data which the network node 411, 412, 413 gets reports on from the wireless communication device 415, associated with the wireless communication device 415, in the transmit buffer 910 of the first network node 411,

an estimate of a bit rate of the first radio link 421,

a first probability that the first network node 411 schedules the wireless communication device 415 at the transmission opportunity at the first network node 412, and

a second probability that the second network node 412 schedules the wireless communication device 415 at the transmission opportunity at the second network node 412. The scheduling of the wireless communication device 415 may comprise scheduling DL transmissions to the wireless communication device 415 andor scheduling UL transmissions from the wireless communication device 415.

For example, if the wireless communication device 415 is not likely to be scheduled at the first upcoming transmission opportunity at the second radio link 422 but at the second transmission opportunity, the time for switching is set just prior to the second transmission opportunity on the radio link 422. Setting the time for switching just prior to the transmission opportunity means that the switch functionality considers the delay until there is data available at the second radio link 422 when the transmission opportunity at the second network node 412 occur. In other words, by setting the time for switching just prior to the transmission opportunity the user plane data is available at the second radio link 422 at the latest at the start of the transmission opportunity, e.g. a subframe, at the second radio link 422.

In some embodiments the time for switching is set just prior to the transmission opportunity, such as a Tx scheduling occasion, for which the scheduling probability is above a threshold.

In some other embodiments the time for switching is set randomly to just prior to one out of a multiple of transmission opportunities, such as Tx scheduling occasions, when scheduling probabilities have been obtained. For example, the scheduling probabilities may relate to a probability that the second network node 412 schedules the wireless communication device 415 at the transmission opportunities.

The transmission opportunity at the second network node 412, andor the transmission opportunity at the first network node 411 may be a next transmission opportunity following a time for providing the indication of the time for switching the radio link. The next transmission opportunity may comprise one or more transmission opportunities. The time for providing the indication is a time when the network node 411, 412, 413 provides the indication.

### Action 504

In some embodiments herein the network node 411, 412, 413 adapts a scheduling priority of the wireless communication device 415 based on the indication of the time for switching the radio link. The scheduling priority may be associated with the first radio link 421. The scheduling priority may be adapted by e.g. increasing or decreasing the scheduling priority.

Adapting the scheduling priority based on the indication of the time for switching the radio link decreases the risk for having remaining user plane data associated with the wireless communication device 415 in the transmit buffer 910 of the first network node 411 at the time for switching.

Adapting the scheduling priority may be implemented as part of a radio delay scheduler 920 in the network node 411, 412, 413.

The radio delay scheduler 945 may e.g. give a first wireless communications device a higher scheduling priority than a second wireless communications device as the first wireless communications device is to be switched 10 ms from a specific transmission opportunity and the second wireless communications device is to be switched at 100 ms from the same specific transmission opportunity.

In other words, the radio delay scheduler 920 may e.g. set and provide a first time for switching the first wireless communications device at 10 ms from the evaluation time, and set and provide a second time for switching the second wireless communications device at 100 ms from the evaluation time. Then the radio delay scheduler 920 may give the first wireless communications device a higher scheduling priority than the second wireless communications device. The scheduling priority may be a priority with respect to in which order andor when to be scheduled. That is, the first wireless communications device having a higher scheduling priority will be prioritized over the second wireless communication device when determining which wireless communication device to schedule.

### Action 505

The network node 411, 412, 413 may switch the radio link for the user plane associated with the wireless communication device 415 at the provided time for switching.

### Further Embodiments

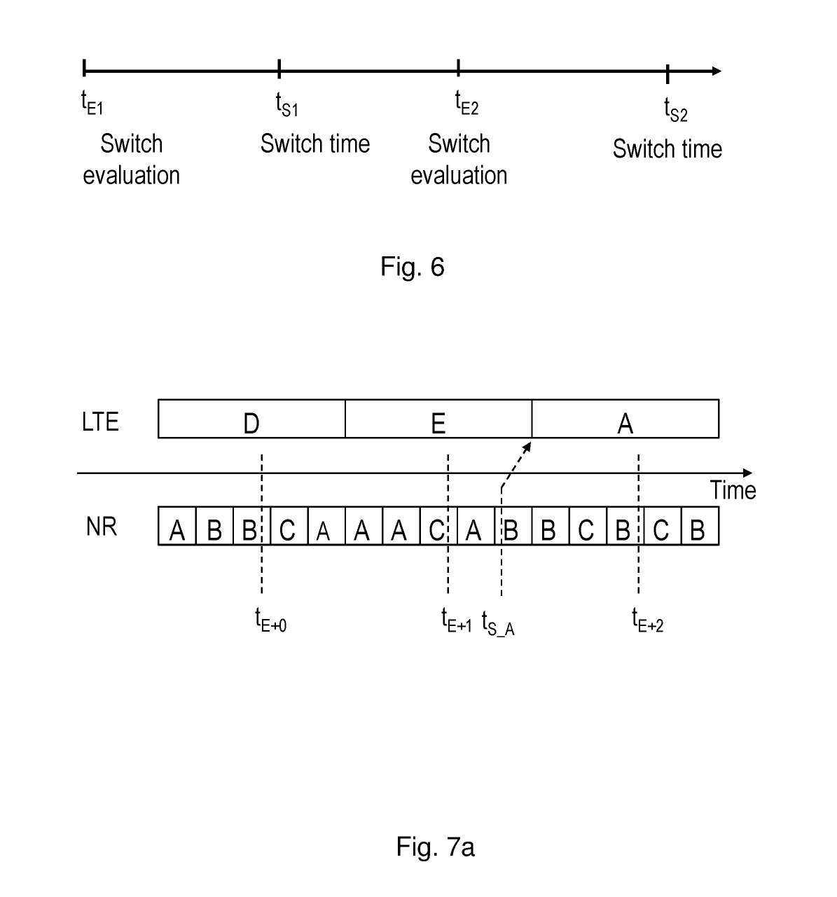

FIG. 6 illustrates a possible relation of switch evaluation time and switch time.

As mentioned above, switch criteria may be based on the signal strength of the channel used in the respective access technology, e.g. RSRP or some sort of quality measurement such as SINR or RSRQ. These switch criteria may be evaluated at given periodic time instances or when triggered by an event. For example, the switch criteria may be evaluated due to that a signal strength associated with the first radio link 421 or the second radio link 422 is worse or better than a threshold relative the other radio link. Periodic triggering may be governed by a timer.

The periodic option is shown in FIG. 6. At each time for evaluating switching, e.g. switch evaluation time, t_{E1}, an evaluation of the switch criteria is performed, e.g. for the wireless communication device 415, while the actual switch of the wireless communication device 415 may be done at a following time for switching, e.g. switch time t_{S1}. The switch time may be set and provided as described above in action 503. At the switch evaluation time the network node 411, 412, 413 may select which wireless communication devices that are to be switched, e.g. based on the switch criteria. At the next switch evaluation time t_{E2} the switch criteria algorithm is run again.

In embodiments herein the network node 411, 412, 413 may determine or set the time for switching radio link so that a switch of radio links, also referred to as a radio link switch, from the first radio link 421 to the second radio link 422 is performed prior to the next transmission opportunity, such as the next transmission time interval, of the second radio link 422. This allows the wireless communication device 415 to use additional transmission opportunities on the first radio link 421, e.g. on the current connection.

In some embodiments a switch decision functionality 930 in the network node 411, 412, 413 has knowledge about a time alignment of the two connections, e.g. of the first radio link 421 and the second radio link 422. Then the switch decision functionality 930 may calculate the next potential transmission opportunity or opportunities, such as one or more scheduling occasions, on both radio links based on the time alignment and set the time for switching thereafter.

In some other embodiments, the switch decision functionality 930 has not knowledge about the time alignment. Then it will inquire a scheduler 940 also referred to as a scheduler functionality of the two connections, e.g. of the first radio link 421 and the second radio link 422, for the time of next potential transmission opportunity or opportunities, such as the next few upcoming scheduling occasions, and set the time for switching thereafter. The first network node 411 may comprise the scheduler 940 and the second network node 412 may comprise the scheduler 940.

In yet some further embodiments the scheduler 940 updates the switch decision functionality 930 with the time of the next potential transmission opportunity or opportunities when the switch evaluation is triggered. That is, in some embodiments, e.g. when the first network node 411 is an MeNB and the second network node 412 is an SeNB, the scheduler 940 of the second network node 412 updates the switch decision functionality 930 of the first network node 411. In some other embodiments when the first network node 411 is an MeNB and the second network node 412 is an SeNB the scheduler 940 of the second network node 412 updates the switch decision functionality 930 of the third network node 413.

Generally the switch decision functionality 930 may reside in any of the network nodes 411, 412, 413. The scheduler 940 may reside in both the first network node 411 and in the second network node 412 for their respective radio links 421, 422. Generally, the time of next potential transmission opportunity or opportunities may be transmitted between the network nodes 411, 412, 413, e.g. over the interfaces 431, 432, 433.

In yet some further embodiments related to action 503 above, the network node 411, 412, 413 calculates probabilities for how likely it is that the wireless communication device 415 will be scheduled at the next, e.g. few, upcoming scheduling occasions of the first radio link 421 and of the second radio link 422. The network node 411, 412, 413 then sets the time for switching based on these probabilities. Hence, if the wireless communication device 415 is not likely to be scheduled at the first upcoming transmission opportunity at the second radio link 422 but at the second transmission opportunity, the time for switching is set just prior to the second transmission opportunity on the radio link 422.

In yet some further embodiments related to action 503 above, the network node 411, 412, 413 sets the time for switching also based on the amount of DL data in the transmit buffer of the scheduler 940 of the first network node 411.

The network node 411, 412, 413 may further set the time for switching based on a PDCP buffer status. Depending on DC configuration, e.g. depending on which user plane architecture is used, the PDCP buffer status mentioned above may refer to the PDCP buffer status of the first radio link 421, or the PDCP buffer status of the second radio link 422 or both. For example, if the split bearer type is used, the PDCP buffer status mentioned above may refer to the PDCP buffer status of the first radio link 421. If the MCG bearer type and the SCG bearer type is used, the PDCP buffer status mentioned above may refer to both PDCP buffer status of the first radio link 421 and the second radio link 422.

For example, in order to avoid packet forwarding or packet discard of the data in the transmit buffer of the scheduler in the first network node 411, a calculation may be made at the switch evaluation time to estimate how many transmissions are needed to empty or bring down the amount of data in the transmit buffers, for example MAC, RLC, and PDCP transmit buffers, to a reasonable level and set the switch time thereafter. This may be advantageous since e.g. the RLC and MAC transmit buffers may be subject for packet forwarding andor packet discard due to the switch.

In some embodiments the network node 411, 412, 413 considers the amount of data in the Tx buffers 910 of the first network node 411, and an estimate of the link bit rate of the wireless communication device 415 until a time of one out of a multiple of next upcoming transmission opportunities on the first radio link 421. The amount of data and the estimate of the radio link bit rate are used to calculate remaining data in the Tx buffer 910 of the first network node 411 at each potential switch occasion. Similarly, the remaining data in a Tx buffer of the wireless communication device 415 may also be calculated. The network node 411, 412, 413 may further consider the input rate to the buffer levels of the transmitter to calculate the remaining data in the Tx buffers at each potential switch occasion.

The switch occasion may thereafter be set to the occasion which fulfill a condition or threshold of an amount of remaining data in the Tx buffer.

In some further embodiments the network node 411, 412, 413 may spread out the switch times of several wireless communication devices which have been identified to be switched at the current switch evaluation. This is to avoid switching a large number of wireless communication devices at the same time and thereby avoid large bursts of data on the connection 431 between the first network node 411 and the second network node 412.

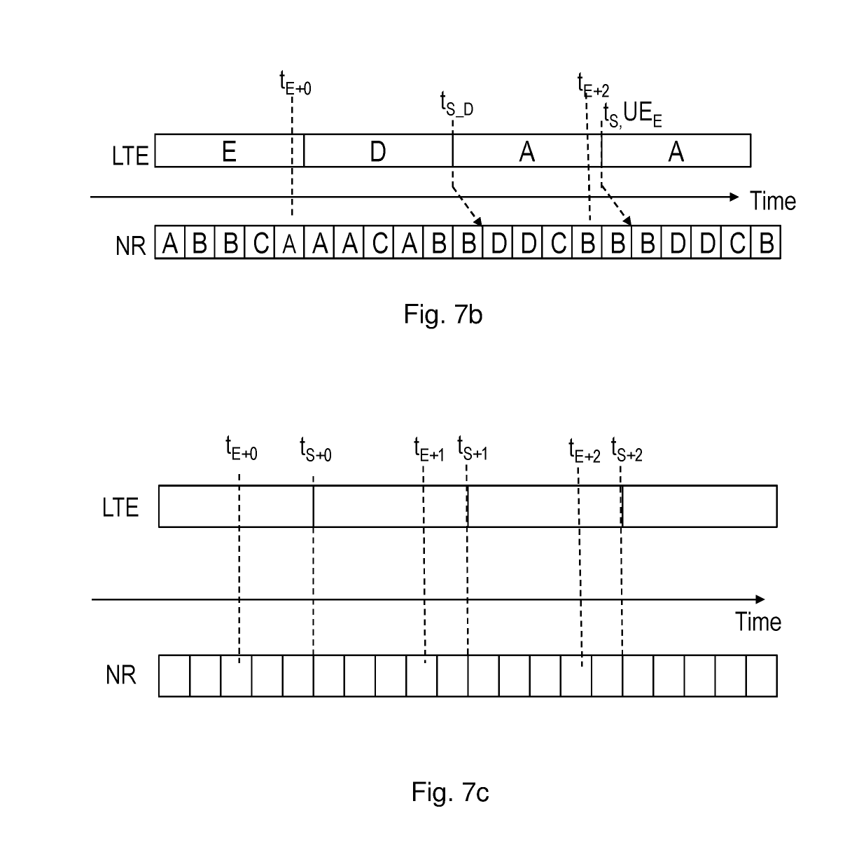

FIG. 7a illustrates a time axis and a simplified relation between transmission opportunities on the first radio link 421 and on the second radio link 422. More specifically, FIG. 7a illustrates a simplified TTI relation between an LTE radio link and a NR radio link. FIG. 7a further illustrates evaluation time and switch time with individual switch times for different wireless communication devices, such as different UEs A, B, C, D and E. FIG. 7a further illustrates how switching is performed from the NR link to the LTE link.

At time t_{E+0} no UE fulfilled a switch criteria. The switch criteria may for example be the switch criteria mentioned above. At time t_{E+1} switch criteria are fulfilled for UEA, which means that UE A will be scheduled on next TTI in order to empty the Tx buffer of the network node 411, 412, 413 from user plane data associated with UE A prior to switching the user plane of UE A from the NR link to the LTE link at time t_{s_A}. At time t_{E+2} no UE fulfilled the switch criteria.

FIG. 7b illustrates how switching is performed from the NR link to the LTE link. At time t_{E+0} switch criteria are fulfilled for UE D, which means that UE D will be scheduled on next TTI to empty the Tx buffer of user plane data associated with UE D prior to switching the user plane of UE D from the NR link to the LTE link at time t_{s_D}. At time t_{E+2} switch criteria are fulfilled for UE E. Since the transmit buffer associated with UE E is empty the switch is imminent.

FIG. 7c illustrates an example where the switch time is not dependent on a specific wireless communication device. Instead the switch time may depend on which cell andor RAT the first network node 411 operates according to.

As mentioned above, each network node, such as the first network node 411 and the second network node 412, may be configured to report information related to the switch time to the other nodes, such as data levels in transmitter buffers, time of upcoming transmission opportunities, and scheduling probability for the wireless communication device 415. In some embodiments it is the scheduler functionality of the network nodes that is configured to do the above.

The sending andor receiving of information related to the switch time may be done prior or after selection of a particular wireless communication device for switching. This depends on for example the amount of signaling “allowed”, e.g. link signaling capabilities, andor which information that is used for selecting the wireless communication devices to be switched. The selection of which wireless communication devices that are to be considered for switching may be based on e.g. the signal strength as mentioned earlier. It may also be based on other metrics such as amount of data in respective Tx buffers of each connectionlink, resource usage associated with the wireless communication devices, operator policy, and activity level of the wireless communication devices.

The network node 411, 412, 413 may collect the information that is used as input for setting the switch time, including time of next scheduling occasions, scheduling probability that is specific for the wireless communication device 415, information of the transmitter buffers which are related to the wireless communication device 415, as input to decide the link switch time. The transmitter buffers may comprise the transmitter buffer of the wireless communication device 415 andor the transmitter buffer of the first network node 411.

The first network node 411 and the second network node 412 may each be configured to report the information that is used as input for setting the switch time to each other andor to the third network node 413, either periodically or conditional or both. Such information may be obtained in different ways as listed below.
1) Handover measurement results in terms of the radio channel quality and buffer of the wireless communication device 415
2) The Buffer Status Report (BSR) of the wireless communication device 415
3) Channel Quality Indicator(CQI)Channel State Information (CSI) report and the measurement of UL sounding signals, provided by the wireless communication device 415
4) Additionally, active user contexts for selecting who and how many wireless communication devices to evaluate with the switching criteria, the information that is used as input for setting the switch time, such as, information of the DL buffers associated with the wireless communication device 415, may be provided by the first network node 411 and the second network node 412, e.g. from the SeNB to the MeNB, e.g. via the X2 interface. The MeNB may configure what kind of measurements that should be provided by the SeNB via a measurement configuration signaling, as shown in FIG. 8a.

FIG. 8a illustrates further embodiments related to signaling of the above information that is used as input for setting the switch time. In FIG. 8a the first network node 411 is illustrated as an MeNB, and the second network node 412 is illustrated as an SeNB.

FIG. 8b illustrates yet further embodiments related to signaling of switch information.

As mentioned above the network node 411, 412, 413 makes a decision 811 to switch the user plane of the wireless communication device 415 from the first radio link 421 to the second radio link 422.

The wireless communication device 415 may be informed 812 of the link switch by the network node 411, 412, 413, e.g. by the first network node 411, via an existing control channel, e.g. a Physical Downlink Control Channel (PDCCH) or a similar channel, or via a dedicated RRC signaling.

In case that the wireless communication device 415 is going to switch to an SeNB link, the MeNB, such as the first network node 411, may also inform the SeNB, such as the second network node 412, via the first interface 431, e.g. the X2 interface. The signaling information may comprise an identity of the wireless communication device 415 and the switching time. In that case the SeNB may further signal 813 the wireless communication device 415 via its DL control channels.

Embodiments herein may be performed in the network node 411, 412, 413. The network node 411, 412, 413 may comprise the modules mentioned above and depicted in FIG. 9.

The network node 411, 412, 413 is configured to, e.g. by means of a providing module 950 configured to, provide an indication of the time for switching the radio link for the user plane associated with the wireless communication device 415. The radio link is switched from the first radio link 421, associated with the first network node 411, to the second radio link 422 associated with the second network node 412. The time for switching the radio link is based on an obtained indication of the transmission opportunity of the user plane data at the second network node 412.

The providing module 950 may be implemented by a processor 980 in the network node 411, 412, 413.

The network node 411, 412, 413 may further be configured to, e.g. by means of the adapting module 960 configured to, adapt the scheduling priority of the wireless communication device 415 based on the indication of the time for switching the radio link.

The adapting module 960 may be implemented by the processor 980 in the network node 411, 412, 413.

The network node 411, 412, 413 may further be configured to, e.g. by means of a transmitter 971 configured to, transmit data and control signals to the wireless communication device 415.

The network node 411, 412, 413 may further be configured to, e.g. by means of a receiver 972 configured to, receive data and control signals from the wireless communication device 415.

In conclusion, embodiments herein describe a method and apparatus for aligning the switch time with the upcoming transmission opportunities of two radio links. The radio links may belong to two different RATs.

Embodiments herein enable e.g. user plane switching at the PDCP layer between LTE and NR that is data transfer efficient and avoids missing out on scheduling occurrences on the current RAT and minimises possible packet forwarding which introduces user pane latency.

The embodiments herein may be implemented through one or more processors, such as the processor 980 in the network node 411, 412, 413, depicted in FIG. 9 together with computer program code for performing the functions and actions of the embodiments herein. The program code mentioned above may also be provided as a computer program product 991, for instance in the form of a data carrier carrying computer program code 992 for performing the embodiments herein when being loaded into the network node 411, 412, 413. One such carrier may be in the form of a CD ROM disc. It is however feasible with other data carriers such as a memory stick. The computer program code may furthermore be provided as pure program code on a server and downloaded to the network node 411, 412, 413.

Thus, the methods according to the embodiments described herein for the network node 411, 412, 413 may be implemented by means of a computer program product, comprising instructions, e.g., software code portions, which, when executed on at least one processor, cause the at least one processor to carry out the actions described herein, as performed by the network node 411, 412, 413. The computer program product may be stored on a computer-readable storage medium. The computer-readable storage medium, having stored there on the computer program, may comprise the instructions which, when executed on at least one processor, cause the at least one processor to carry out the actions described herein, as performed by the network node 411, 412, 413. In some embodiments, the computer-readable storage medium may be a non-transitory computer-readable storage medium.

The network node 411, 412, 413 may further comprise a memory 990, comprising one or more memory units. The memory 990 is arranged to be used to store obtained information such as an obtained indication of a transmission opportunity of a user plane data at the second network node 412, an obtained indication of a transmission opportunity of the user plane data at the first network node 411, an amount of data, associated with the wireless communication device 415, in a transmit buffer of the first network node 411, an estimate of a bit rate of the first radio link 421, a first probability that the first network node 411 schedules the wireless communication device 415 at the transmission opportunity at the first network node 412, and a second probability that the second network node 412 schedules the wireless communication device 415 at the transmission opportunity at the second network node 412, resource usage of the wireless communication device 415, operator policy, activity level of the wireless communication device 415, and applications etc. to perform the methods herein when being executed in the network node 411, 412, 413.

Those skilled in the art will also appreciate that the different modules described above may refer to a combination of analog and digital circuits, and/or one or more processors configured with software andor firmware, e.g. stored in the memory, that when executed by the one or more processors, such as the processors in the network node 411, 412, 413 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, e.g. meaning “consist at least of”.

The embodiments herein are not limited to the above described preferred embodiments. Various alternatives, modifications and equivalents may be used. Therefore, the above embodiments should not be taken as limiting the scope.

Although specific terms may be employed herein, they are used in a generic and descriptive sense only and not for purposes of limitation.

Therefore, the above embodiments should not be taken as limiting the scope, which is defined by the appending claims.

Note that although terminology from 3GPP NR and LTESAE has been used in this disclosure to exemplify the embodiments herein, this should not be seen as limiting the scope of the embodiments herein to only the aforementioned system. Other wireless systems may also benefit from exploiting the ideas covered within this disclosure.

Also note that terminology such as a first network node and a second network node should be considered to be non-limiting and does in particular not imply a certain hierarchical relation between the two.

1. A method for operating a network node, the method comprising:
providing an indication of a time for switching a radio link for a user plane associated with a wireless communication device, wherein the radio link is switched from a first radio link, associated with a first network node, to a second radio link associated with a second network node (412), and wherein the time for switching the radio link is based on an obtained indication of a transmission opportunity of a user plane data at the second network node.

2. The method according to claim 1, wherein the time for switching is further based on an obtained indication of a transmission opportunity of the user plane data at the first network node.

3. The method according to claim 1, wherein the time for switching is further based on any one or more of:
an amount of data, associated with the wireless communication device, in a transmit buffer of the first network node,
an estimate of a bit rate of the first radio link,
a first probability that the first network node schedules the wireless communication device at the transmission opportunity at the first network node, and
a second probability that the second network node schedules the wireless communication device at the transmission opportunity at the second network node.

4. The method according to claim 1, wherein the transmission opportunity at the second network node, and/or the transmission opportunity at the first network node is a next transmission opportunity following a time for providing the indication of the time for switching the radio link.

5. The method according to claim 1, further comprising:
adapting a scheduling priority of the wireless communication device based on the indication of the time for switching the radio link.

6. A network node, configured to:
provide an indication of a time for switching a radio link lor a user plane associated with a wireless communication device, wherein the radio link is switched from a first radio link, associated with a first network node, to a second radio link associated with a second network node, and wherein the time for switching the radio link is based on an obtained indication of a transmission opportunity of a user plane data at the second network node.

7. The network node according to claim 6, wherein the time for switching is further based on an obtained indication of a transmission opportunity of the user plane data at the first network node.

8. The network node according to claim 6, wherein the time for switching is further based on any one or more of:
an amount of data, associated with the wireless communication device, in a transmit buffer of the first network node,
an estimate of a bit rate of the first radio link,
a first probability that the first network node schedules the wireless communication device at the transmission opportunity at the first network node, and
a second probability that the second network node schedules the wireless communication device at the transmission opportunity at the second network node.

9. The network node according to claim 6, wherein the transmission opportunity at the second network node, and/or the transmission opportunity at the first network node is a next transmission opportunity following a time for providing the indication of the time for switching the radio link.

10. The network node according to claim 6, further configured to:
adapt a scheduling priority of the wireless communication device based on the indication of the time for switching the radio link.
